(19) United States
(12) Patent Application Publication
(10) Pub. No.: US 2010/0096306 A1
(43) Pub. Date: Apr. 22, 2010

(54) WATER FILTER WITH STERILIZING FUNCTION

(76) Inventor: Chih-Chao Chang, Taipei (TW)

Correspondence Address: PATENTTM.US, P. O. BOX 82788, PORTLAND, OR, 97282-0788, US

(21) Appl. No.: 12/502,729

(22) Filed: Jul. 14, 2009

(30) Foreign Application Priority Data
Oct. 16, 2008 (TW) 097218471

(51) Int. Cl. B01D 35/14

(52) U.S. Cl. 210/89; 210/202; 210/105; 210/87

(57) ABSTRACT

A water filter with a sterilizing function has a filtering device, a sterilizing device and a pipe connecting the filtering device and the sterilizing device. The filtering device has a water inlet and a water outlet. The water inlet is connected with a water supplying pipe for receiving water. The sterilizing device has an inlet and an outlet. The outlet is connected with an output pipe for providing water. The inlet is connected to the water outlet of the filtering device. The water flows through the filtering device and the sterilizing device as it goes through the water filter. Therefore, chemical materials and bacteria in the drinking water are removed.

### BACKGROUND OF THE INVENTION

1. Field of the Invention

The invention relates to a water filter with the sterilizing function and, in particular, to a water filter that uses ultraviolet (UV) light to kill bacteria.

2. Description of Related Art

To remove impurities and harmful chemical materials from drinking water, most families or factories install a water filter at the water outlet to take away harmful chemicals from the water.

However, the causes that make people sick by water are not just due to the chemicals. The sickness may also be caused by bacteria that are invisible to naked eyes. Therefore, merely filtering out the harmful chemicals is insufficient. Bacteria such as Staphylococcus aureus and Escherichia coli have to be considered as well.

Most water filters on the market only use a filtering core to adhere and thus filter out chemicals in water. They cannot remove or kill harmful bacteria therein. Therefore, the filtered water may still make man sick.

To overcome the shortcomings, the present invention provides a water filter with sterilizing function to mitigate or obviate the aforementioned problems.

### SUMMARY OF THE INVENTION

An objective of the invention is to provide a water filter with the sterilizing function. The water filter can kill bacteria in water that are harmful to human bodies. Therefore, people using the invention are less likely to get sick from drinking water containing bacteria.

To achieve the above-mentioned objective, the water filter includes a filtering device, a sterilizing device, and a pipe connecting between them. The filtering device has a water inlet and a water outlet. The water inlet is connected to a water supplying pipe with a water flow switch for receiving water. The sterilizing device has an inlet and an outlet. The outlet is connected with an output pipe for providing water.

Using the above-mentioned technique, drinking water is guided by the water supplying pipe to the filtering device for removing chemicals therein. Afterwards, the pipe leads the filtered water into the sterilizing device for sterilization, thereby removing bacteria harmful to human bodies. Finally, the processed water flows out of the output pipe for drinking. Therefore, chemicals and bacteria harmful to human bodies are removed to ensure the purity and safety of the drinking water.

### BRIEF DESCRIPTION OF THE DRAWINGS

FIG. 1 is a perspective view of a preferred embodiment of a water filter in accordance with the present invention;

FIG. 2 is a partially exploded perspective view of the water filter;

FIG. 3 is an exploded perspective view of a sterilizing device of the water filter;

FIG. 4 is a cross-sectional view of the sterilizing device of FIG. 3;

FIG. 5 is another cross-sectional view of the sterilizing device of FIG. 3;

FIG. 6 shows the water flow in the water filter in accordance with the present invention;

FIG. 7 is a block diagram of a control circuit of the water filter;

FIG. 8 is a detailed circuit diagram of FIG. 7; and

FIG. 9 is a flow chart showing the procedures of turning a UV lamp on and off of the sterilizing device in accordance with the present invention.

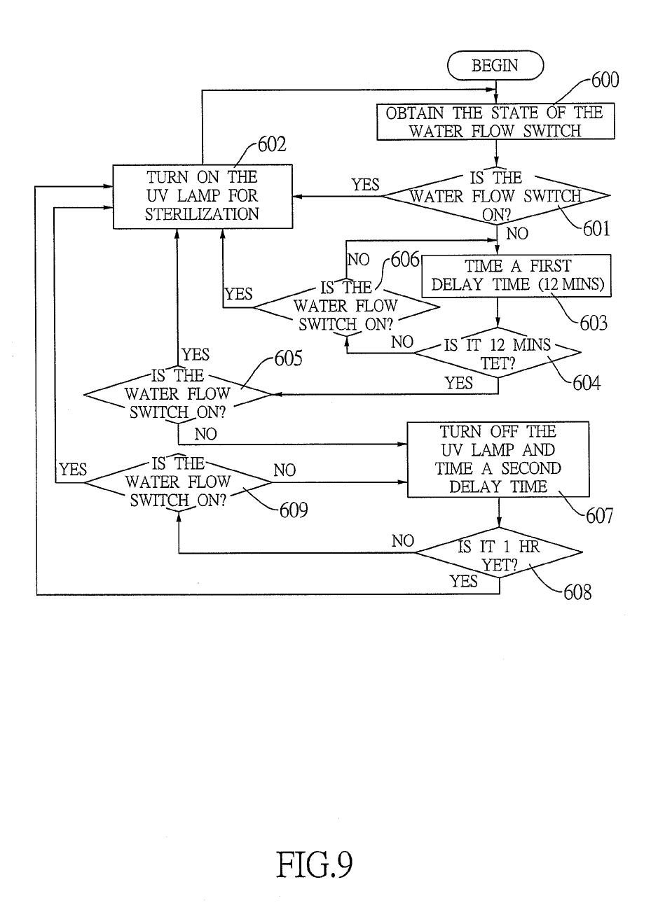

### DETAILED DESCRIPTION OF THE PREFERRED EMBODIMENT

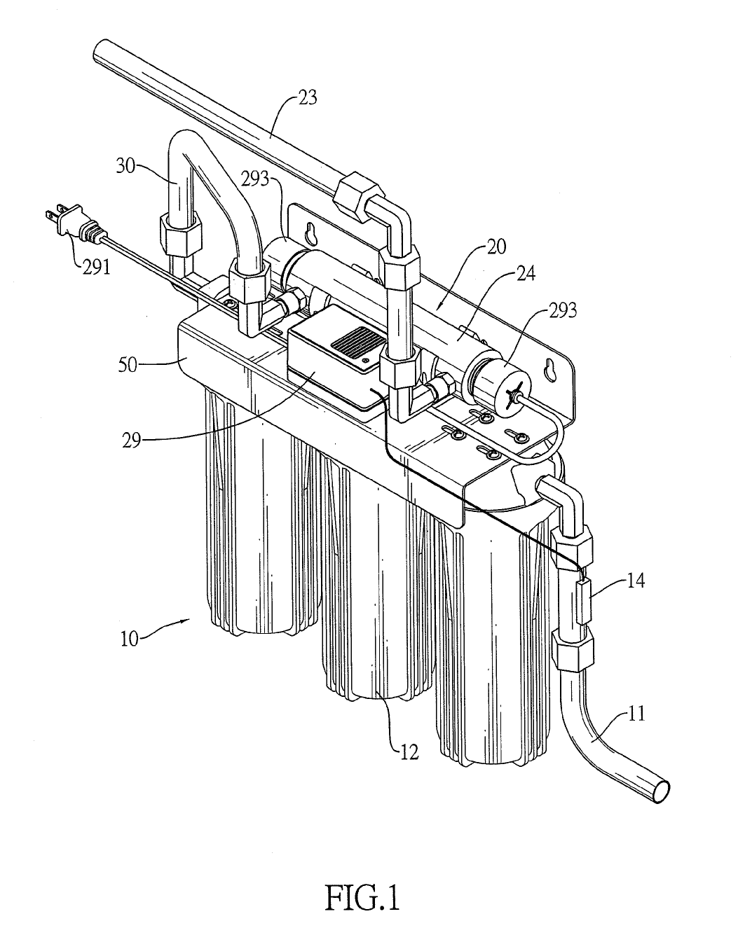

With reference to FIGS. 1, 2 and 6, a water filter with the sterilizing function in accordance with the present invention comprises a filtering device 10, a sterilizing function 20, a pipe 30, and a bracket 50.

The filtering device 10 has a water inlet 15 and a water outlet 16. The water inlet 15 is connected with a water supplying pipe 11 with a water flow switch 14 for receiving water. In this embodiment, the filtering device 10 comprises multiple filter cores 12 and more than one connecting pipes 13. The filter cores 12 are interconnected by the connecting pipes 13 to form a pipeline.

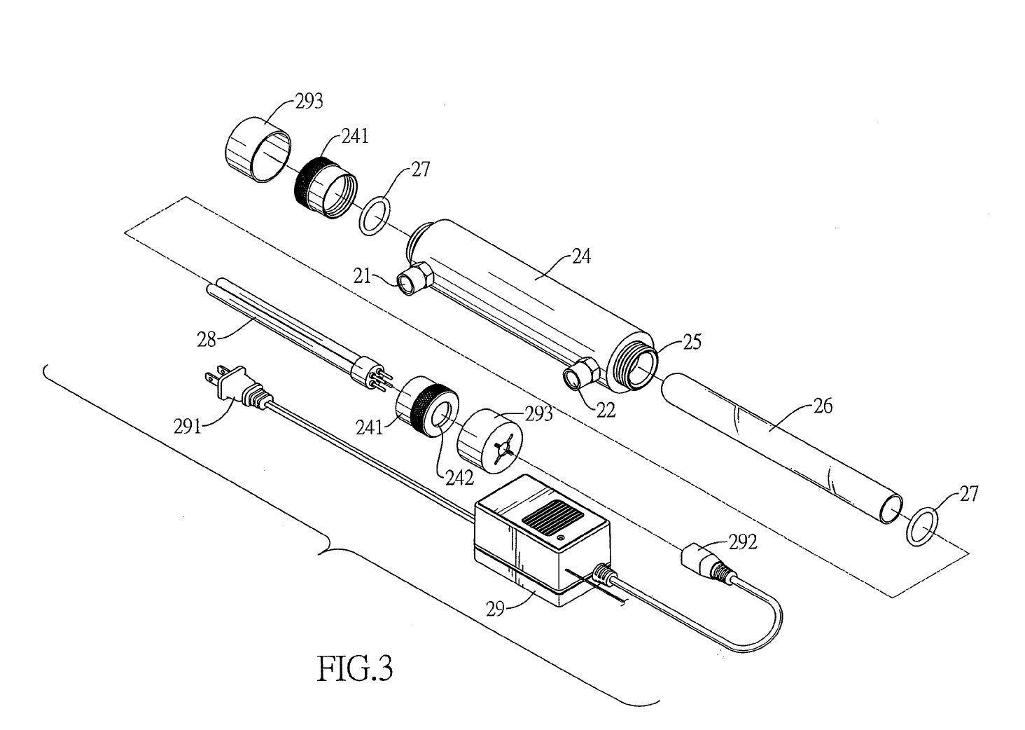

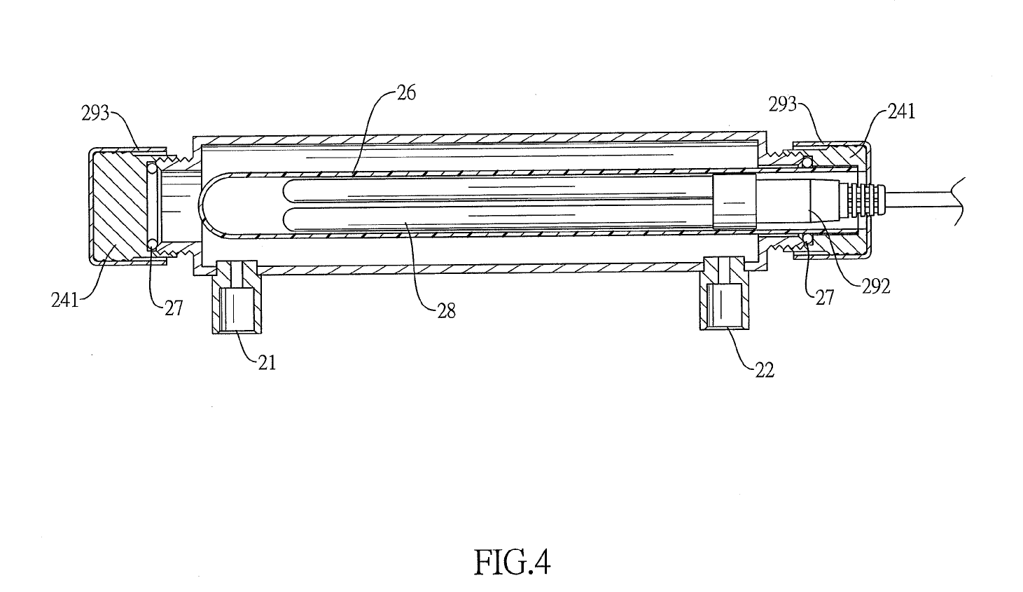

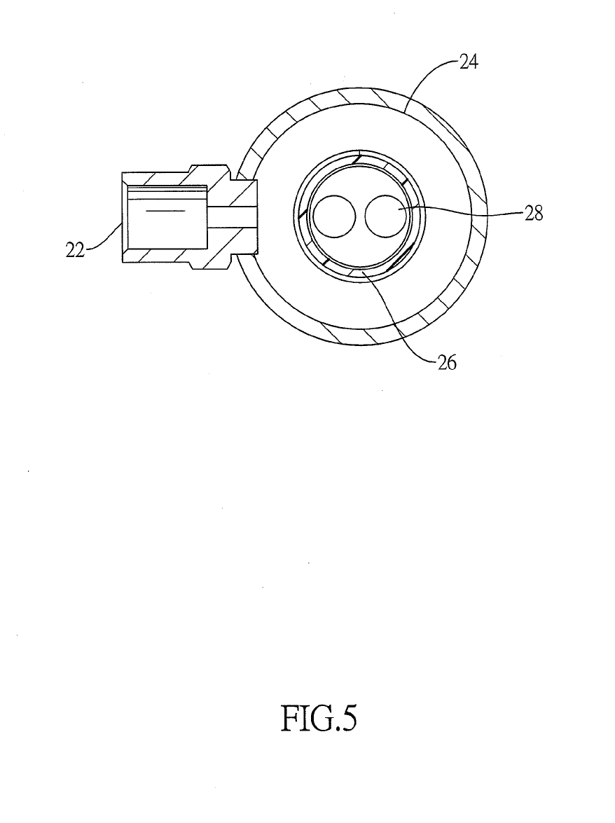

With reference to FIGS. 3 to 5, the sterilizing device 20 has an inlet 21 and an outlet 22. The outlet 22 is connected with an output pipe 23 for providing water. In this embodiment, the sterilizing device 20 is comprised of an outer pipe 24, a transparent inner pipe 26, two sealing washers 27, an UV lamp 28, and a control box 29. The outer pipe 24 is formed with the inlet 21 and the outlet 22 on the sidewalls of both ends. Both ends of the outer pipe 24 are formed with an installation opening 25. Each of the installation openings 25 is threadingly fastened with a pipe cover 241. One of the sealing washers 27 is mounted between the pipe cover 241 and the installation opening 25. One of the pipe covers 241 has a connecting hole 242. The UV lamp 28 is mounted in the inner pipe 26. The inner pipe 26 is inserted via the installation opening 25 into the outer pipe 24. One end of the inner pipe 26 is fixed at the installation opening 25 using the pipe cover 241.

When the water flow switch 14 is turned on, the control box 29 immediately turns on the UV lamp 28 for sterilization. When the water flow switch 14 is turned off, the control box 29 waits for some time before the UV lamp 28 is shut off. This allows the water in the outer pipe 24 to be sterilized. This prevents the user to drink unsterilized water next time. The water flow switch 14 controls the electric power of the water filter, so that the water filter consumes power only when in use. Moreover, this sterilizing manner prevents water inside the sterilizing device 20 from generating a high temperature and causing dangers because it is not used for a long time.

The control box 29 has a plug 291 and a connector 292. The plug 291 is connected to an external power source. The connector 292 extends through the connecting hole 242 of the pipe cover 241 and is connects to the UV lamp 28 to provide the electric power for activating the UV light. Moreover, the connector 292 may go through a sleeve element 293. The sleeve element 293 can be further mounted on the pipe cover 241 of the outer pipe 24 to prevent the connector 292 from falling off the UV lamp 28.

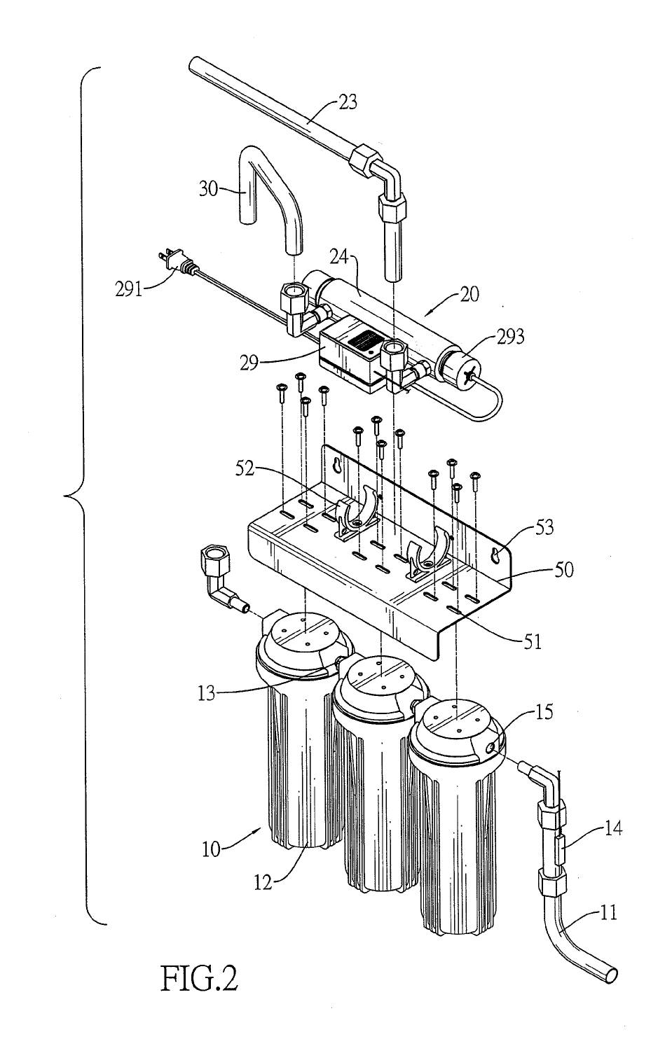

With reference to FIG. 2 again, the pipe 30 is connected between the filtering device 10 and the sterilizing device 20 for water to flow through.

The bracket 50 has several fixing holes 51 for screw-fastening the filter cores 12 underneath it. The bracket 50 further has multiple C-shaped fixing clips 52 for clipping the sterilizing device 20. Besides, the bracket 50 is formed with several hanging holes 53 for the user to hang it on a wall.

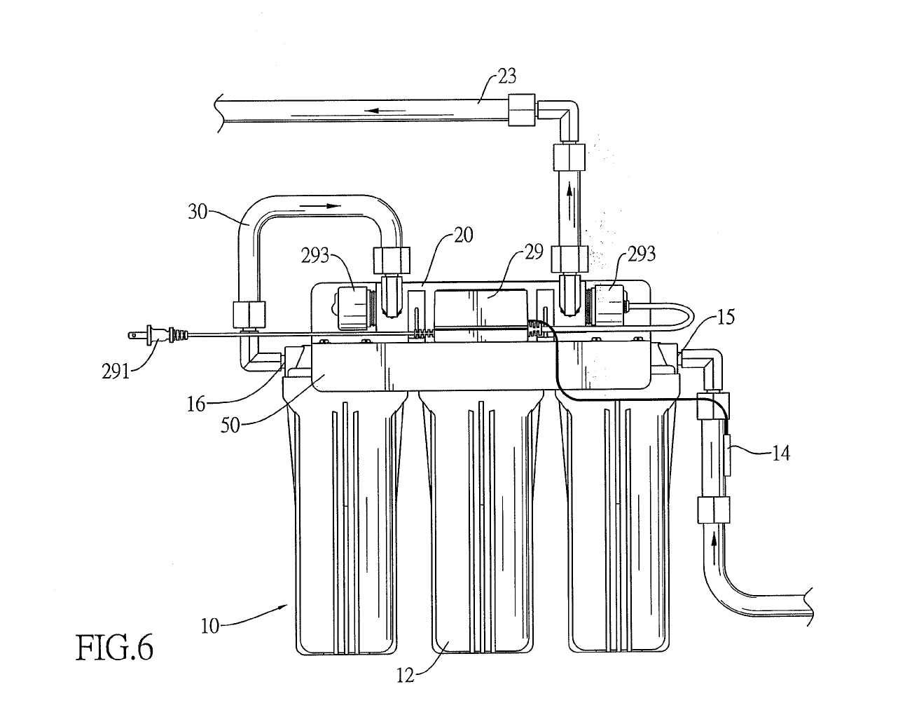

With reference to FIG. 6, when in use, water first flows from the water supplying pipe 11 into the filter cores 12 of the filtering device 10 for removing chemical materials therein. Afterwards, the drinking water flows between the outer pipe 24 and the inner pipe 26 in the sterilizing device 20. The UV light produced by the UV lamp 28 thus kills the harmful bacteria in the water. In the end, the drinking water flows out of the output pipe 23 for the users to drink. Using this design, harmful chemicals and bacteria can be simultaneously removed from the drinking water, so that its user will not get sink from it.

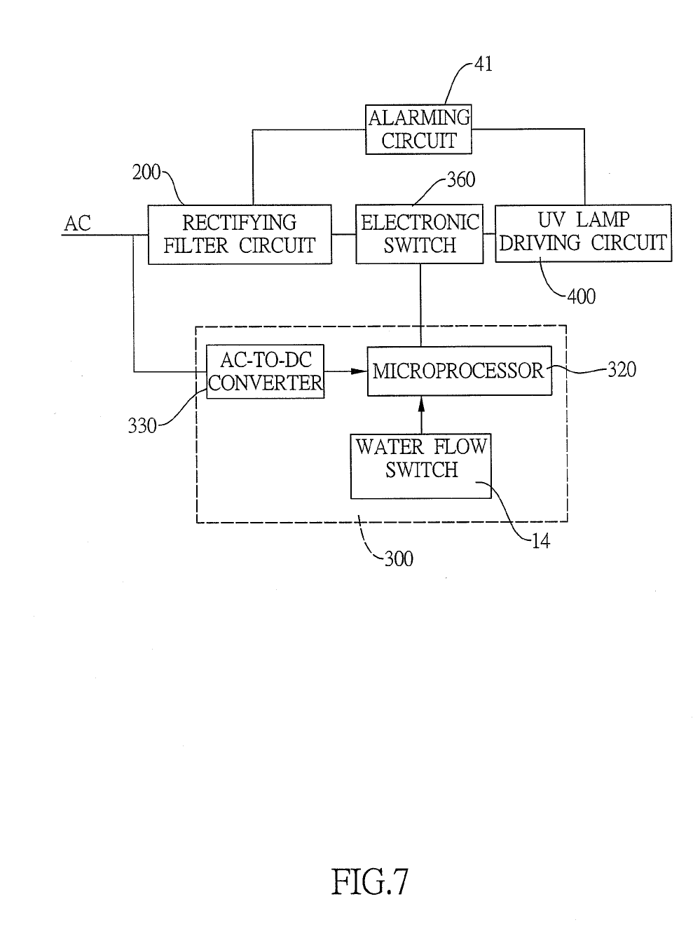

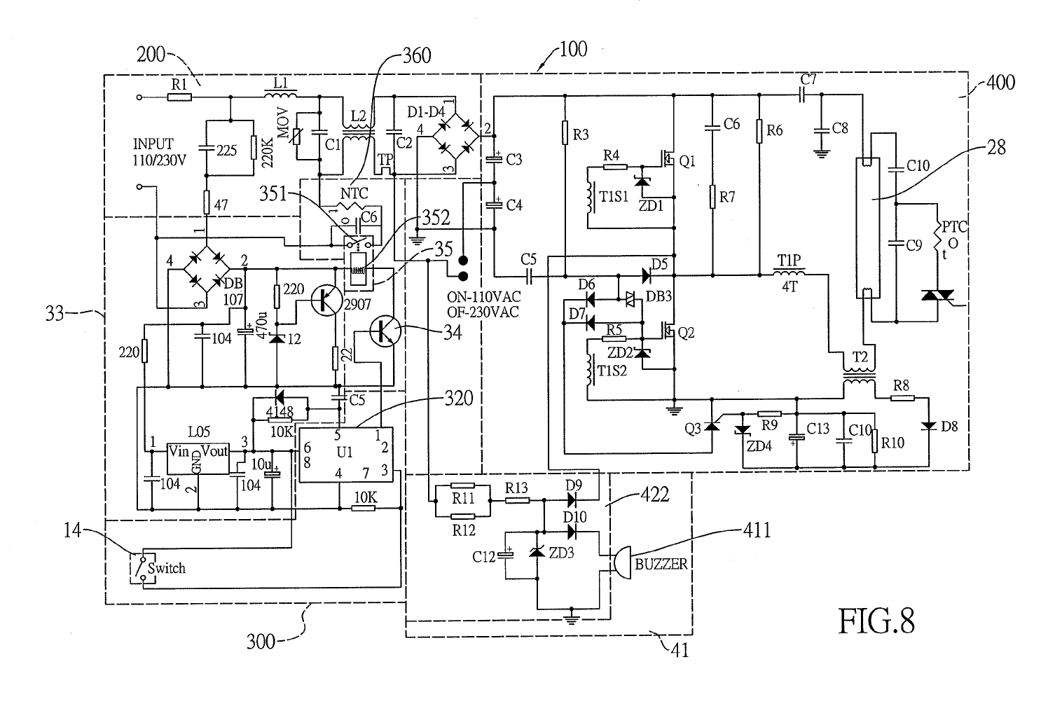

With reference to FIGS. 7 and 8, a control circuit 100 for the sterilizing device 20 comprises a rectifying filter circuit 200, an electronic switch 360, a control unit 300, a microprocessor 320, an AC-to-DC power converting circuit 330, and a UV lamp driving circuit 400.

The rectifying filter circuit 200 is connected to an AC power supply and converts the AC power into DC power for output. The electronic switch 360 is connected in series to the rectifying filter circuit 200. The control unit 300 is connected to the rectifying filter circuit 200 via the electronic switch 360, controls the power supplied to the rectifying filter circuit 200. The control unit 300 further includes the water flow switch 14 for detecting the pressure of the water flow, thereby determining the on/off state.

The microprocessor 320 is connected to the water flow switch 14 and stores a UV lamp control procedure. According to the on/off of the water flow switch 14, the microprocessor 320 controls the on/off state of the electronic switch 360. When the water flow switch 14 is turned off, the control procedure of the UV lamp 28 executes to alternately turn on and off the electronic switch 360.

The AC-to-DC power converting circuit 330 converts the AC power to DC power, and further lowers and stabilizes the DC power to a low DC voltage and outputs the low DC voltage to the input terminals of the microprocessor 320.

The UV lamp driving circuit 400 is connected to the output terminals of the rectifying filter circuit 200 to obtain DC power, and converts the DC power into high-frequency AC power to drive the UV lamp 28.

The electronic switch 360 comprises a transistor 34 and a relay 35. The relay 35 includes a switch 351 and a magnetic coil 352. The switch is connected in series to the power circuit of the rectifying filter circuit 200. The transistor 34 is connected between the microprocessor 320 and the magnetic coil 352 of the relay 35. The microprocessor 320 controls the current that flows through the magnetic coil 352 via the transistor 34.

With reference to FIG. 3, the UV lamp control procedure of the microprocessor 320 comprises the following steps.

Step 600 obtains the water flow state.

Step 601 determines whether the water flow switch is turned on. If so, then the UV lamp 28 is turned on for sterilization (step 602). Otherwise, the next step 603 is performed to execute a first delay time. That is, it starts timing the first delay time (e.g., 12 minutes).

Step 604 determines whether the first delay time has reached. If the first delay time has reached, then the procedure determines whether the water flow switch is turned on (step 605). If the water flow switch is turned on, then the UV lamp 28 is turned on for sterilization (step 602), followed by going back to the first step. If the water flow switch 14 is turned off, then the next step 607 is executed.

If the first delay time has reached, the procedure determines whether the water flow switch 14 is turned on (step 606). If the water flow switch 14 is turned on, then the UV lamp 28 is turned on for sterilization (step 602), followed by going back to the first step. Otherwise, step 603 of executing a first delay time is performed.

Step 607 turns off the UV lamp 28 and enters a second delay time. This starts timing the second delay time (e.g., 1 hour). Step 608 determines whether the second delay time is reached. Once the second delay time is reached, the UV lamp is turned on for sterilization (step 602), followed by going back to the first step. If the second delay time is not reached, then the procedure determines whether the water flow switch is on (step 609). If the water flow switch is on at this moment, then the UV lamp is turned on for sterilization (step 602), followed by going back to the first step. Otherwise, the UV lamp is kept off until the second delay time is reached. In that case, the UV lamp is turned on again and the procedure goes back to the first step.

Detailed circuit actions of the control circuit in the water filter are described as follows:

When a user wants to drink water, the water flow switch 14 is turned on. At this moment, the microprocessor 320 determines that the water flow switch 14 is on. The microprocessor 320 thus turns on the electronic switch 360, and the rectifying filter circuit 200 forms a closed loop for powering the UV lamp driving circuit 400 to activate the UV lamp 28. The UV light then sterilizes the drinking water.

When the user is not drinking, the water flow switch 14 is turned off. In this case, the microprocessor 320 determines that the water flow switch 14 is off. It then starts to time the first delay time (e.g. 12 minutes). That is, the microprocessor 320 continues to let the electronic switch 360 on, so that the rectifying filter circuit 200 keeps powering the UV lamp 28 to sterilize the drinking water stayed in the sterilizing pipe 541. This lasts until the first delay time is over. If the state of the water flow switch 14 changes from off to during the period, the microprocessor 320 zeros the first delay time.

If after the first delay time reaches and the water flow switch 14 is on, then the microprocessor 320 turns on the electronic switch 360 to power the UV lamp 28 for sterilization. If the water flow switch 14 is still off, then the microprocessor 320 stops powering the UV lamp 28 until the second delay time is reached. Therefore, the invention can save energy. If the water flow switch 14 becomes on within the second delay time, then the microprocessor 320 zeros the second delay time and turns on the electronic switch 360 to power the UV lamp 28 for sterilization. If the water flow switch keeps off after the second delay time, then the microprocessor 320 repeats the process of turning the UV lamp 28 on and off intermittently. This process prevents bacteria from growing in the sterilizing pipe.

This embodiment further includes an alarming circuit 41 connected between the rectifying filter circuit 200 and the UV lamp driving circuit 400. The alarming circuit 41 includes a buzzer 411 and a buzzer control circuit 422. If the UV lamp 28 is burnt out or short-circuits, the buzzer control circuit 422 detects it and controls the buzzer 411 to make a loud voice, notifying the user to replace the UV lamp 28 or perform other maintenance actions. This ensures that even when the water filter is installed at a hidden place, the user can be notified whether the sterilizing function is working or not.

According to the above description, when the water flow switch 14 is turned on, the microprocessor 320 immediately controls to power the UV lamp 28. UV light is emitted to sterilize the drinking water. When the water flow switch 14 is turned off, the microprocessor 320 delays the first delay time before it shuts off the UV lamp 28. This allows sufficient time to kill bacteria in the water inside the sterilizing pipe. When the next time the water flow switch is on, the user can get completely sterilized drinking water. Moreover, if the water flow switch 14 is off for a long time, the microprocessor 320 turns off the UV lamp 28 when the first delay time is reached and starts timing the second delay time. When the second delay time is reached, the microprocessor 320 turns on the UV lamp 28 and keeps it on for the first delay time. Afterwards, the UV lamp 28 is turned off again. The timing of second delay time starts. Such an intermittent sterilizing process continues. It achieves the effects of completely sterilizing the drinking water and reducing carbon production.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A water filter with sterilizing function comprising:
a filtering device having a water inlet and a water outlet, with the water inlet connected to a water supplying pipe for receiving water, the water supplying pipe is mounted with a water flow switch;
a sterilizing device having an inlet and an outlet, with the outlet connected to an output pipe for outputting water; and
a pipe connected between the filtering device and the sterilizing device.

2. The water filter with sterilizing function as claimed in claim 1, wherein
the sterilizing device comprising an outer pipe, a transparent inner pipe, two sealing washers, an ultraviolet (UV) lamp, and a control box;
the outer pipe has two ends and two installation opening, the inlet and the outlet of the sterilizing device are formed through the outer pipe near the two ends respectively, the two installation opening are respectively screw-fastened with a pipe cover formed with a connecting hole;
a sealing washer is interposed between each pipe cover and the installation opening;
the inner pipe is mounted in the outer pipe via the installation opening and has one end fixed at the installation opening by one of the pipe covers;
the UV lamp is mounted in the inner pipe.

3. The water filter with sterilizing function as claimed in claim 1, wherein the filtering device comprises multiple filter cores and multiple connecting pipes interconnected among the filter cores.

4. The water filter with sterilizing function as claimed in claim 2, wherein the filtering device comprises multiple filter cores and multiple connecting pipes interconnected among the filter cores.

5. The water filter with sterilizing function as claimed in claim 3 further comprising
a bracket having a plurality of fixing holes for screw-fastening the filter cores underneath the bracket, wherein the bracket is mounted with a plurality of fixing clips for fixing the sterilizing device and formed with a plurality of hanging holes for hanging on a wall.

6. The water filter with sterilizing function as claimed in claim 4 further comprising
a bracket having a plurality of fixing holes for screw-fastening the filter cores underneath the bracket, wherein the bracket is mounted with a plurality of fixing clips for fixing the sterilizing device and formed with a plurality of hanging holes for hanging on a wall.

7. The water filter with sterilizing function as claimed in claim 2, wherein the sterilizing device includes a control circuit comprising:
a rectifying filter circuit connected with an AC power supply and converting the AC power to DC power;
an electronic switch connected in series to the rectifying filter circuit;
a control unit connected to the electronic switch and to the rectifying filter circuit for controlling power supplied to the rectifying filter circuit, the control unit further including:
the water flow switch for detecting the pressure of water flow;
a microprocessor connected to the water flow switch and built in with a UV lamp control procedure, wherein the microprocessor turns on and off the electronic switch according to on and off status of the water flow switch and turns the UV lamp on and off intermittently when the water flow switch is turned off; and
an AC-to-DC power converter connected to the AC power supply for converting the AC power into DC power, lowering and stabilizing the DC power to be output to the microprocessor; and
a UV lamp driving circuit connected to the output terminals of the rectifying filter circuit for obtaining the DC power and converting the DC power into high-frequency AC power that drives the UV lamp.

8. The water filter with sterilizing function as claimed in claim 7, wherein the electronic switch includes:
a relay having a switch and a magnetic coil, with the switch connected in series to the rectifying filter circuit; and
a transistor connected between the microprocessor and the magnetic coil of the relay for the microprocessor to control the magnetic coil via the transistor.

9. The water filter with a sterilizing function as claimed in claim 8 further comprising an alarming circuit connected between the rectifying filter circuit and the UV lamp driving circuit, the alarming circuit including a buzzer and a buzzer control circuit.

10. The water filter with sterilizing function as claimed in claim 9, wherein the UV lamp control procedure comprises the steps of:
obtaining a state of the water flow switch;
determining whether the water flow switch is on and, if yes, turning on the UV lamp or, if no, executing the next step;
timing a first delay time;
determining whether the first delay time is reached and,
if the first delay time is reached, determining whether the water flow switch is on and, if the water flow switch is on, turning on the UV lamp and going back to the first step or, if the water flow switch is off, executing the next step or; and
if the first delay time is not yet reached, further determining whether the water flow switch is on and, if the water flow switch is on, turning on the UV lamp and going back to the first step or otherwise timing the first delay time;
turning off the UV lamp and timing a second delay time;
determining whether the second delay time is reached and,
if the second delay time is reached, turning on the UV lamp and going back to the first step or, if the second delay time is not reached, further determining whether the water flow switch is on; and
if the water flow switch is on, turning on the UV lamp and going back to the first step or otherwise keeping the UV lamp off until the second delay time is reached, followed by turning on the UV lamp and going back to the first step.
